(19) United States
(12) Patent Application Publication
(10) Pub. No.: US 2015/0285950 A1
(43) Pub. Date: Oct. 8, 2015

(54) Systems and Methods for Selecting Facies Model Realizations

(71) Applicant: Landmark Graphics Corporation, Houston, TX (US)

(72) Inventors: Jeffrey Yarus, Houston, TX (US); Marko Maucec, Englewood, CO (US); Richard Chambers, Yukon, OK (US); Genbao Shi, Sugar Land, TX (US)

(21) Appl. No.: 14/350,262

(22) PCT Filed: Feb. 10, 2012
(86) PCT No.: PCT/US12/24651

§ 371 Date: Apr. 7, 2014

(51) Int. Cl. G01V 99/00

(52) U.S. Cl. CPC G01V 99/005

(57) ABSTRACT

Systems and methods for selecting facies model realizations based on the cumulative distribution function of facies net volumes.

### CROSS-REFERENCE TO RELATED APPLICATIONS

None

### STATEMENT REGARDING FEDERALLY SPONSORED RESEARCH

Not applicable.

### FIELD OF THE INVENTION

The present invention generally relates to selecting facies model realizations. More particularly, the invention relates to selecting facies model realizations based on the cumulative distribution function of facies net volumes.

### BACKGROUND OF THE INVENTION

Modern geostatistical practices often rely on uncertainty analysis to assess the statistical variance (spread) of measured data and prepare the input models for subsequent risk management workflows. Capturing model uncertainty using probabilistic (stochastic) simulation methods usually involves the generation of many equally probable scenarios and realizations of reservoir properties that best mimic the reservoir heterogeneity such as, for example, facies distribution, porosity or permeability, which may also be referred to as facies model realizations. Moreover, conditional simulation techniques are used to constrain reservoir property models with variables such as, for example, acoustic impedance (AI) from the inversion of seismic data. In this manner, a more accurate representation of spatial distribution and a more representative and unbiased statistical sampling may be achieved.

It is, however, unlikely that the constructed models of reservoir properties truly represent the actual reservoir heterogeneity. Such models often are based on many assumptions that affect different scales of the model. For example, the most influential assumptions in the geomodeling process are large-scale assumptions that affect the structural and stratigraphic model, the depositional environment, perturbations in structural surfaces or the position of faults. Other small-scale assumptions like the choice of variogram models or parameters, algorithm selection or changes to probability (or cumulative) density functions may affect only the inter-well space like varying the seed number from realization to realization. The vast variety of interfering variables therefore, makes the identification and selection of the “right” reservoir property model a cumbersome and time-consuming task, prone to subjective decisions. The state-of-the-art workflows for well placement optimization in, for example, in-fill drilling operations rely on selecting the “most probable” geological model with median impact, which is understood to generate the median (i.e. P50) dynamic reservoir simulator response in terms of recovery factor or sweep efficiency. The distribution of (litho)facies in high-resolution geological models is of fundamental importance in procedures that rank the geological uncertainty in reservoir production history matching and forecast workflows as it controls the depositional continuity throughout the reservoir and as such defines the prominent fluid paths.

### SUMMARY OF THE INVENTION

The present invention therefore, meets the above needs and overcomes one or more deficiencies in the prior art by providing systems and methods for selecting facies model realizations based on the cumulative distribution function of facies net volumes.

In one embodiment, the present invention includes a method for selecting a facies model realization, comprising: a) selecting a grid-cell or window location for a facies model realization; b) selecting a most prominent facies for facies within the facies model realization at the grid-cell or window location; c) calculating a volume comprising the selected grid-cell or window location using a computer processor; d) calculating a facies net volume based on the most prominent facies selected and the volume; e) calculating a probability density function of the facies net volume; f) calculating a cumulative distribution function of the facies net volume using the probability density function; and g) selecting the facies model realization if the cumulative distribution function for the facies net volume meets a predetermined value.

In another embodiment, the present invention includes a non-transitory program carrier device tangibly carrying computer executable instructions for selecting a facies model realization. The instructions being executable to implement: a) comprising: a) selecting a grid-cell or window location for a facies model realization; b) selecting a most prominent facies for facies within the facies modelrealization at the grid-cell or window location; c) calculating a volume comprising the selected grid-cell or window location; d) calculating a facies net volume based on the most prominent facies selected and the volume; e) calculating a probability density function of the facies net volume; f) calculating a cumulative distribution function of the facies net volume using the probability density function; and g) selecting the facies model realization if the cumulative distribution function for the facies net volume meets a predetermined value.

In yet another embodiment, the present invention includes a method for selecting a facies model realization, comprising: a) selecting a most prominent facies for facies within a facies model realization at each grid-cell or window location; b) summing the most prominent facies for each grid-cell or window location with the same (i,j) coordinates; c) calculating a volume comprising each grid-cell or window location with the same (i,j) coordinates and a different (k) coordinate using a computer processor; d) calculating a facies net volume for each volume based on the sum of the most prominent facies for each grid-cell or window location with the same (i,j) coordinates and a respective volume comprising each grid-cell or window location with the same (i,j) coordinates; e) summing the facies net volume(s); f) repeating steps a)-e) for each facies model realization; g) calculating a probability density function of the summed facies net volume(s) for all facies model realizations; h) calculating a cumulative distribution function of the summed facies net volume(s) for all facies model realizations using the probability density function; and i) selecting a facies model realization based on the cumulative distribution function of a corresponding facies net volume.

In yet another embodiment, the present invention includes a non-transitory program carrier device tangibly carrying computer executable instructions for selecting a facies model realization. The instructions being executable to implement: a) selecting a most prominent facies for facies within a facies model realization at each grid-cell or window location; b) summing the most prominent facies for each grid-cell or window location with the same (i,j) coordinates; c) calculating a volume comprising each grid-cell or window location with the same (i,j) coordinates and a different (k) coordinate; d) calculating a facies net volume for each volume based on the sum of the most prominent facies for each grid-cell or window location with the same (i,j) coordinates and a respective volume comprising each grid-cell or window location with the same (i,j) coordinates; e) summing the facies net volume(s); f) repeating steps a)-e) for each facies model realization; g) calculating a probability density function of the summed facies net volume(s) for all facies model realizations; h) calculating a cumulative distribution function of the summed facies net volume(s) for all facies model realizations using the probability density function; and i) selecting a facies model realization based on the cumulative distribution function of a corresponding facies net volume.

Additional aspects, advantages and embodiments of the invention will become apparent to those skilled in the art from the following description of the various embodiments and related drawings.

### BRIEF DESCRIPTION OF THE DRAWINGS

The present invention is described below with references to the accompanying drawings in which like elements are referenced with like reference numerals, and in which:

FIG. 1 is a flow diagram illustrating one embodiment of a method for implementing the present invention.

FIG. 2 illustrates the results of step 108 in FIG. 1.

FIG. 3 is a flow diagram illustrating another embodiment of a method for implementing the present invention.

FIG. 4A illustrates an example of step 303 in FIG. 3.

FIG. 4B illustrates another example of step 303 in FIG. 3.

FIG. 5 illustrates the top layer of 9 facies model realizations arbitrarily selected from a group of 400 facies model realizations.

FIG. 6 illustrates an exemplary histogram used in step 115 of FIG. 1, which is based on a group of 400 facies model realizations.

FIG. 7 illustrates a probability density function (PDF), which is calculated in step 115 of FIG. 1 based on the histogram in FIG. 6.

FIG. 8 illustrates a cumulative distribution function (CDF), which is calculated in step 116 of FIG. 1 based on the PDF in FIG. 7.

FIG. 9 illustrates the selection of three facies model realizations based on the facies net volumes selected in step 117 of FIG. 1 and the CDF in FIG. 8.

FIG. 10 is a block diagram illustrating one embodiment of a system for implementing the present invention.

### DETAILED DESCRIPTION OF THE PREFERRED EMBODIMENTS

The subject matter of the present invention is described with specificity, however, the description itself is not intended to limit the scope of the invention. The subject matter thus, might also be embodied in other ways, to include different steps or combinations of steps similar to the ones described herein, in conjunction with other present or future technologies. Moreover, although the term “step” may be used herein to describe different elements of methods employed, the term should not be interpreted as implying any particular order among or between various steps herein disclosed unless otherwise expressly limited by the description to a particular order. While the present invention may be applied in the oil and gas industry, it is not limited thereto and may also be applied in other industries to achieve similar results.

The present invention includes systems and methods for selecting facies model realizations based on the cumulative distribution function of facies net volumes. The cumulative distribution function of the facies net volumes will enable identification and selection of facies model realizations corresponding to the distribution of most probable geostatistical realizations, while giving a fair consideration to the overall span of geological uncertainty. The present invention therefore, can be used in dynamic reservoir characterization workflows and includes systems and methods for: 1) unconstrained selection of facies model realizations over the entire model (e.g. geocellular grid); and 2) spatially constrained selection of facies model realizations, which is constrained within an assigned area or value of interest.

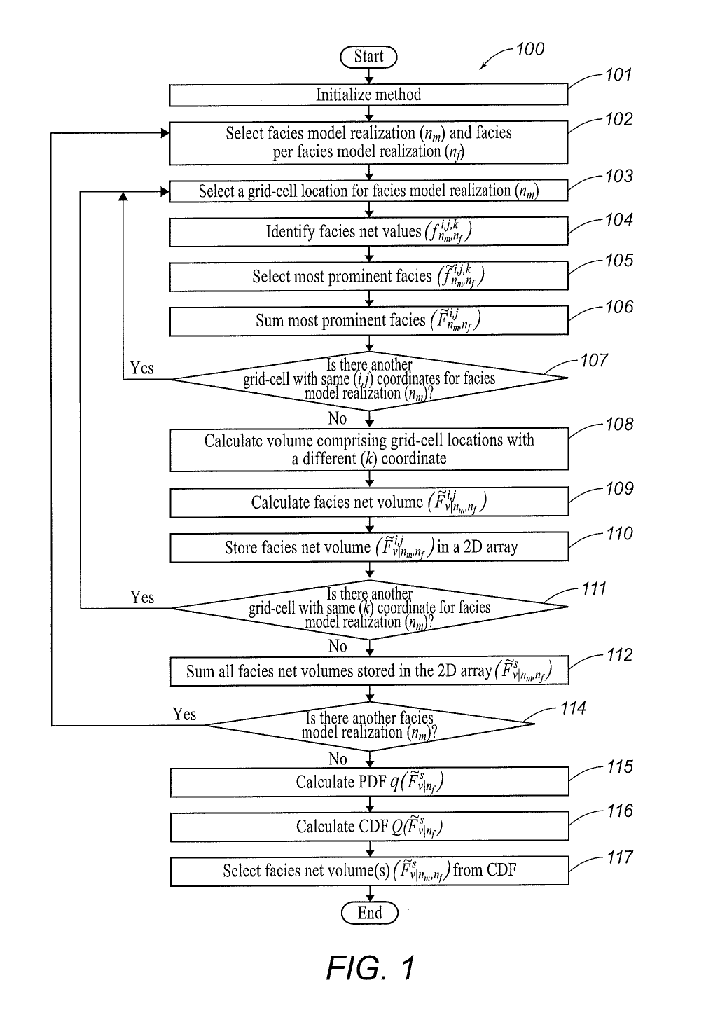

Referring now to FIG. 1, a flow diagram illustrates one embodiment of a method 100 for implementing the present invention.

In step 101, the method 100 is initialized by:
Identifying the number of facies model realizations: nₘ=[1 . . . Nₘ]
Identifying the number of facies per facies model realization: n_{f}=[1 . . . N_{f}]
Identifying the number of grid-cells and their locations: i=[1 . . . I], j=[1 . . . J], k=[1 . . . K] in each facies model realization (nₘ);
Setting the sum of the most prominent facies: \tilde{F}ₙ_{ₘ}ₙ_{_{f}}^{i,j}=0; and
Setting the cumulative distribution function of facies net volumes: \tilde{F}_{v|nf}^{s}=0.

In step 102, a facies model realization (nₘ) and the facies per facies model realization (n_{f}) are randomly or systematically selected.

In step 103, a grid cell location for the facies model realization (nₘ) may be randomly or systematically selected. A grid cell with coordinates (1,1,1) may be selected, for example.

In step 104, the facies net values (fₙ_{ₘ}ₙ_{_{f}}^{i,j,k}) are identified for the facies per facies model realization (n_{f}) at the grid cell location selected in step 103.

In step 105, the most prominent facies (\tilde{f}ₙ_{ₘ}ₙ_{_{f}}^{i,j,k}), which may be the facies with the highest net value, is selected for the facies per facies model realization (n_{f}) at the grid cell location selected in step 103.

In step 106, the most prominent facies are summed at the grid-cell location selected in step 103. Thus, the sum of the most prominent facies at each grid-cell location selected in step 103 with a different (k) coordinate may be represented as:

$${\tilde{F}}_{{n}_{m} , {n}_{f}}^{i , j} = {\sum }_{k = 1}^{K} {\tilde{f}}_{{n}_{m} , {n}_{f}}^{i , j , k} \qquad ( 1 )$$

In step 107, the method 100 determines whether there is another grid-cell with the same (i, j) coordinates for the facies model realization (nₘ). If there is another grid-cell with the same (i, j) coordinates for the facies model realization (nₘ), then the method 100 returns to step 103 and selects another grid-cell location with the same (i, j) coordinates and a different (k) coordinate for the facies model realization (nₘ). If there is not another grid-cell with the same (i,j) coordinates for the facies model realization (nₘ), then the method 100 proceeds to step 108. In this manner, step 107 may be used for the structured and unstructured grids. Alternatively, steps 103 through 106 may be performed at the same time for each grid-cell with the same (i, j) coordinates at each (k) coordinate of the facies model realization (nₘ).

In step 108, a volume comprising the grid-cell locations selected in step 103 with a different (k) coordinate may be calculated by:

V^{i,j}=Δx·Δy·Δz=Δx·Δy·Z (2)

where:

Δx=xᵢ₊₁−xᵢ

Δy=yⱼ₊₁−yⱼ

Δz=zₖ₊₁−zₖ (3)

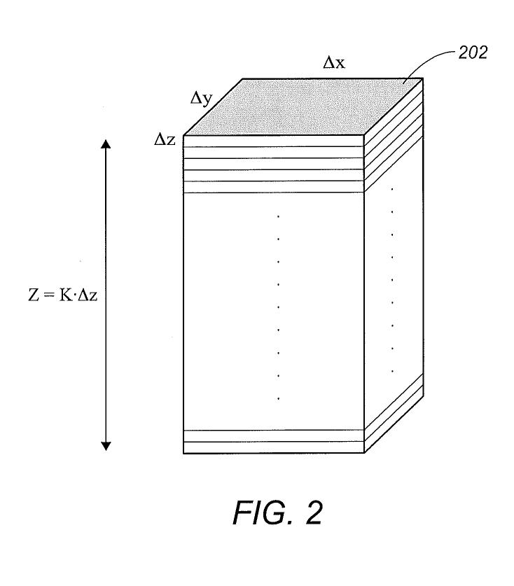

The volume illustrated in FIG. 2, for example, may be calculated by equation (2). Each grid-cell such as, for example, grid-cell 202, includes the same (i, j) coordinates and a different (k) coordinate. For unstructured grids, equation (3) may resume any more generic form of volumetric calculation in combinatorial geometry.

In step 109, the facies net volume (\tilde{F}_{v|n}_{ₘ}_{,n}_{_{f}}^{i,j}) may be calculated by:

\tilde{F}_{v|n}_{ₘ}_{,n}_{_{f}}^{i,j}=\tilde{F}ₙ_{ₘ}_{,n}_{_{f}}^{i,j}·V^{i,j} (4)

where (\tilde{F}ₙ_{ₘ}_{,n}_{_{f}}^{i,j}) is the sum of the most prominent facies from step 106 and (V^{i,j}) is the volume calculated in step 108.

In step 110, the facies net volume (\tilde{F}_{v|n}_{ₘ}_{,n}_{_{f}}^{i,j}) calculated in step 109 is stored in a 2D array.

In step 111, the method 100 determines whether there is another grid-cell with the same (k) coordinate for the facies model realization (nₘ). If there is another grid-cell with the same (k) coordinate for the facies model realization (nₘ), then the method 100 returns to step 103 and selects another grid-cell location with the same (k) coordinate and different (i, j) coordinates for the facies model realization (nₘ). If there is not another grid-cell with the same (k) coordinate for the facies model realization (nₘ), then the method 100 proceeds to step 112. In this manner, step 111 may be used for structured and unstructured grids. Alternatively, steps 103 through 111 may be performed at the same time for each grid-cell with the same (k) coordinate at each (i, j) coordinate of the facies model realization (nₘ).

In step 112, the facies net volumes (\tilde{F}_{v|n}_{ₘ}_{,n}_{_{f}}^{i,j}) stored in step 110 are summed. Thus, the sum of the facies net volumes stored in step 110 may be represented as:

$${\tilde{F}}_{v \vert {n}_{m} , {n}_{f}}^{s} = {\sum }_{i = 1}^{I} {\sum }_{j = 1}^{J} {\tilde{F}}_{v \vert {n}_{m} , {n}_{f}}^{i , j} \qquad ( 5 )$$

where (\tilde{F}_{v|n}_{ₘ}_{,n}_{_{f}}^{i,j}) represents the facies net volume for the entire facies model realization (nₘ) selected in step 102.

In step 114, the method 100 determines whether there is another facies model realization (nₘ). If there is another facies model realization (nₘ), then the method 100 returns to step 102 and selects another facies model realization (nₘ) and the facies (n_{f}) per facies model realization. If there is not another facies model realization (nₘ), then the method 100 proceeds to step 115.

In step 115, a probability density function (q (\tilde{F}_{v|n}_{_{f}}^{s})) or (PDF) of the summed facies net volumes (\tilde{F}_{v|n}_{_{f}}^{s}) for the total number of facies model realizations (Nₘ) is calculated from a histogram of the summed facies net volumes using techniques well known in the art. The summed facies net volumes (\tilde{F}_{v|n}_{_{f}}^{s}) may be represented as:

$${\tilde{F}}_{v \vert {n}_{f}}^{S} = {\sum }_{{n}_{m} = 1}^{{N}_{m}} {\tilde{F}}_{v \vert {n}_{m} , {n}_{f}}^{S} \qquad ( 6 )$$

where (\tilde{F}_{v|n}_{ₘ}_{,n}_{_{f}}^{S}) is the summed facies net volumes from step 112 for each facies model realization (nₘ).

In step 116, a cumulative distribution function (Q(\tilde{F}_{v|n}_{_{f}}^{s})) or CDF is calculated using the probability density function (q (\tilde{F}_{v|n}_{_{f}}^{s})) from step 115 and techniques well known in the art.

In step 117, a facies net volume (\tilde{F}_{v|n}_{ₘ}_{,n}_{_{f}}^{s}) for a single facies model realization (nₘ) from step 112 is selected using the CDF from step 116. For example, the facies net volume (\tilde{F}_{v|n}_{ₘ}_{,n}_{_{f}}^{s}) selected at P50 is tied to a single facies model realization (nₘ). If no discrete facies net volume (\tilde{F}_{v|n}_{ₘ}_{,n}_{_{f}}^{s}) corresponding to a single facies model realization (nₘ) can be selected, then the closest facies net volume (\tilde{F}_{v|n}_{ₘ}_{,n}_{_{f}}^{s}), in terms of absolute difference, to P50 may be selected by solving:

δ_{Fv}=minₙ_{ₘ}₌₁^{N}^{ₘ}|F_{v|n}_{ₘ}−F_{v|P50}| (7)

where (δ_{Fv}) represents the minimized absolute difference between the facies model realization (F_{v|n}_{ₘ}) corresponding with the closest facies net volume (\tilde{F}_{v|n}_{ₘ}_{,n}_{_{f}}^{s}) to P50 and the facies model realization at P50 (F_{v|}P50).

The facies model realization (nₘ) at P50 is the median facies model realization for the selected facies net volume (\tilde{F}_{v|n}_{ₘ}_{,n}_{_{f}}^{s}). In addition to the median (impact) facies model realization, the method 100 can also be used to identify the facies model realization models with the lowest impact as well as the highest impact to represent the entire space of model uncertainty over all quantiles of interest. Thus, the selection of the desired or preferred facies model realization (nₘ) is based on the facies net volume selected in step 117 as a function of the desired or preferred CDF.

Alternatively, the method 100 in FIG. 1 may be spatially constrained. A spatially constrained method can i) identify the 2D areas (or 3D volumes) of the model that contain significant (or highest) proportions of the facies of interest (e.g. particular sand channel); ii) be applied within the area-of-interest or volume-of-interest (AOI/VOI); iii) calculate the pore volume of the corresponding facies of interest within the AOI/VOI; and iv) rank facies model realizations based on spatially constrained results. A spatially constrained method therefore, may be used to identify facies models based on the localized distribution of facies of interest, which will eventually correspond to spatial locations relevant to, for example, selection of in-fill drilling locations in well placement. The AOI/VOI can correspond to any 2D (regular or irregular) shape or any 3D (regular or irregular) body, such as a geo-object or geo-body. Reference herein to a “window” of interest therefore, includes any 2D/3D AOI/VOI. A 2D window of interest, for example, will have dimensions ( [symbol] ^{\tilde{X}}*^{\tilde{Y}}) where (\tilde{X}) and (\tilde{Y}) correspond to x- and y-dimensions of the selected window, respectively, that overlaps with the area of the facies model realization of particular interest. \tilde{X} and \tilde{Y} are defined as:

\tilde{X}=α*Δx

\tilde{Y}=β*Δy (8)

where (α) and (β) correspond to a number of the overlapped (i,j) grid-cells in the x-direction and in the y-direction, respectively.

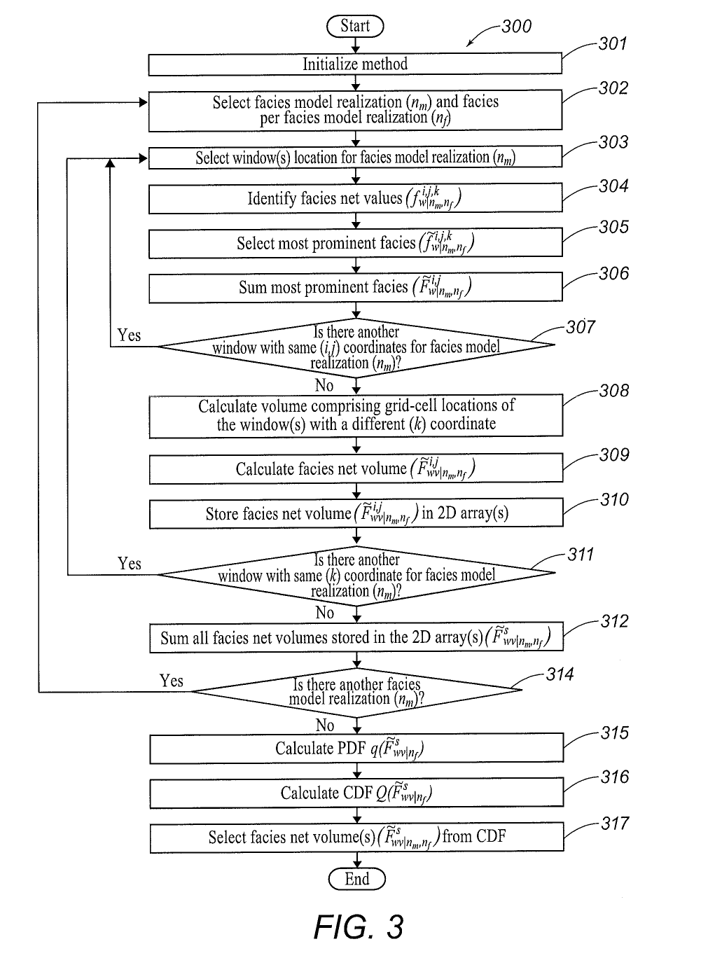

Referring now to FIG. 3, a flow diagram illustrates another embodiment of a method 300 for implementing the present invention. The method 300 is similar to the method 100 in FIG. 1 except that it is a spatially constrained method 300 and is applied within a predefined window that overlaps with grid-cell locations (i_{w}, j_{w}) where usually 1≧i_{w}<I and 1≧j_{w}<J. Variables with the subscript (w) therefore, refer to the overlapping window of grid-cell locations (i_{w}, j_{w}) used in the method 300.

In step 301, the method 300 is initialized by:
Identifying the number of facies model realizations: nₘ=[1 . . . Nₘ]
Identifying the number of facies per facies model realization: n_{f}=[1 . . . N_{f}]
Identifying the number of grid-cells and their locations: i=[1 . . . I], j=[1 . . . J], k=[1 . . . K] in each facies model realization (nₘ);
Setting the sum of the most prominent facies: \tilde{F}_{w/n}_{ₘ}_{,n}_{_{f}}=0; and
Setting the cumulative distribution function of facies net volumes: \tilde{F}_{wv/n}_{_{f}}^{S}=0.

In step 302, a facies model realization (nₘ) and the facies per facies model realization (n_{f}) are randomly or systematically selected.

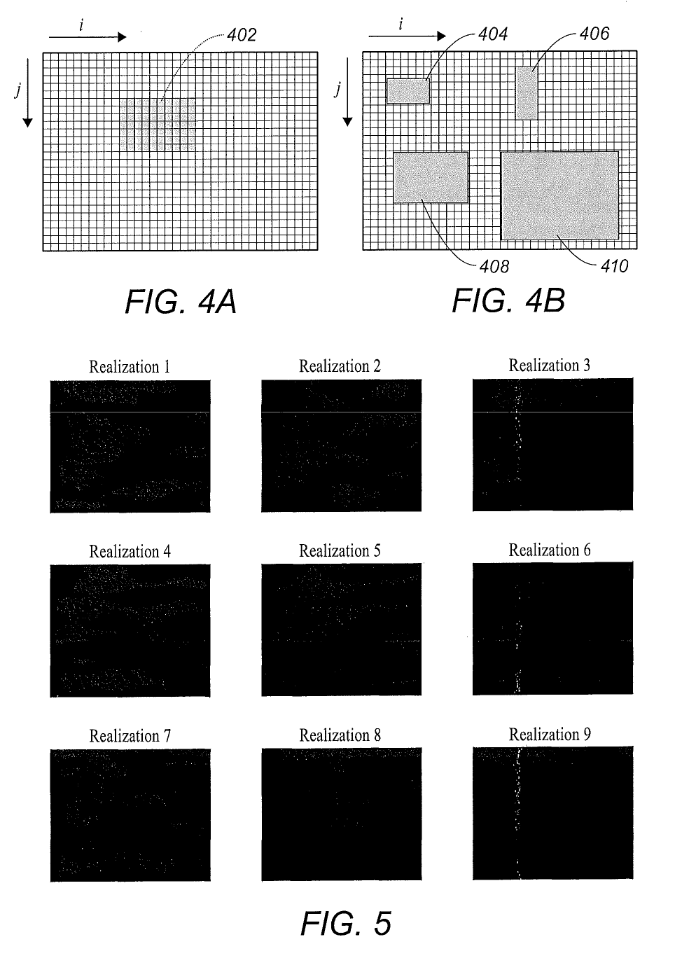

In step 303, the location of the window(s) for the facies model realization (nₘ) may be randomly or systematically selected. In FIG. 4A, for example, an individual window 402 with grid-cell locations (i_{w}, j_{w}) may be selected. A plurality of windows, however, may also be selected as illustrated by windows 404, 406, 408, and 410 in FIG. 4B.

In step 304, the facies net values (f_{w/n}_{ₘ}_{,n}_{_{f}}^{i,j,k}) are identified for the facies per facies model realization (n_{f}) at the grid-cell location of the window(s) selected in step 303.

In step 305, the most prominent facies (\tilde{f}_{w/n}_{ₘ}_{,n}_{_{f}}^{i,j,k}) which may be the facies with the highest net value, is selected for the facies per facies model realization (n_{f}) at the grid cell location of the window(s) selected in step 303.

In step 306, the most prominent facies are summed at the grid-cell location of the window(s) selected in step 303. Thus, the sum of the most prominent facies at each grid-cell location of the window(s) selected in step 303 with a different grid-cell (k) coordinate may be represented as:

$${\tilde{F}}_{w \vert {n}_{m} , {n}_{f}}^{i , j} = {\sum }_{k = 1}^{K} {\tilde{f}}_{w \vert {n}_{m} , {n}_{f}}^{i , j , k} \qquad ( 9 )$$

In step 307, the method 300 determines whether there is another window with the same grid-cell (i, j) coordinates for the facies model realization (nₘ). If there is another window with the same grid-cell (i, j) coordinates for the facies model realization (nₘ), then the method 300 returns to step 303 and selects another grid-cell location of the window(s) with the same grid-cell (i, j) coordinates and a different grid-cell (k) coordinate for the facies model realization (nₘ). If there is not another window with the same grid-cell (i, j) coordinates for the facies model realization (nₘ), then the method 300 proceeds to step 308. In this manner, step 307 may be used for the structured and unstructured grids. Alternatively, steps 303 through 306 may be performed at the same time for each window with the same grid-cell (i, j) coordinates at each grid-cell (k) coordinate of the facies model realization (nₘ).

In step 308, a volume comprising the grid-cell location of the window(s) selected in step 303 with a different grid-cell (k) coordinate may be calculated by:

\tilde{V}ⁱ^{_{w}}^{,j}^{_{w}}=α·Δx·β·Δy·Z=\tilde{X}·\tilde{Y}·X (10)

where:

Δx=xᵢ₊₁−xᵢ

Δy=yⱼ₊₁−yⱼ

Δz=zₖ₊₁−zₖ (11)

For unstructured grids, equation (11) may resume any more generic form of volumetric calculation in combinatorial geometry.

In step 309, the facies net volume (\tilde{F}_{wv|n}_{ₘ}_{,n}_{_{f}}^{i,j}) may be calculated by:

\tilde{F}_{wv|n}_{ₘ}_{,n}_{_{f}}^{i,j}=\tilde{F}_{w/n}_{ₘ}_{,n}_{_{f}}^{i,j}·\tilde{V}ⁱ^{_{w}}^{,j}^{_{w}} (12)

where (\tilde{F}_{wv|n}_{ₘ}_{,n}_{_{f}}^{i,j}) is the sum of the most prominent facies from step 306 and (\tilde{V}ⁱ^{_{w}}^{,j}^{_{w}}) is the volume calculated in step 308.

In step 310, the facies net volume (\tilde{F}_{wv/n}_{ₘ}_{,n}_{_{f}}^{i,j}) calculated in step 309 is stored in 2D array(s).

In step 311, the method 300 determines whether there is another window with the same grid-cell (k) coordinate for the facies model realization (nₘ). If there is another window with the same grid-cell (k) coordinate for the facies model realization (nₘ), then the method 300 returns to step 303 and selects another grid-cell location of the window(s) with the same grid-cell (k) coordinate and different grid-cell (i, j) coordinates for the facies model realization (nₘ). If there is not another window with the same grid-cell (k) coordinate for the facies model realization (nₘ), then the method 300 proceeds to step 312. In this manner, step 311 may be used for structured and unstructured grids. Alternatively, steps 303 through 311 may be performed at the same time for each window with the same grid-cell (k) coordinate at each grid-cell (i, j) coordinate of the facies model realization (nₘ).

In step 312, the facies net volumes (\tilde{F}_{wv|n}_{ₘ}_{,n}_{_{f}}^{i,j}) stored in step 310 are summed. Thus, the sum of the facies net volumes stored in step 310 may be represented as:

$${\tilde{F}}_{wv \vert {n}_{m} , {n}_{f}}^{s} = {\sum }_{i = 1}^{I} {\sum }_{j = 1}^{J} {\tilde{F}}_{wv \vert {n}_{m} , {n}_{f}}^{i , j} \qquad ( 13 )$$

where (\tilde{F}_{wv|n}_{ₘ}_{,n}_{_{f}}^{S}) represents the facies net volume for the entire facies model realization (nₘ) selected in step 302.

In step 314, the method 300 determines whether there is another facies model realization (nₘ). If there is another facies model realization (nₘ), then the method 300 returns to step 302 and selects another facies model realization (nₘ) and the facies (n_{f}) per facies model realization. If there is not another facies model realization (nₘ), then the method 300 proceeds to step 315.

In step 315, a probability density function (q (\tilde{F}_{wv|n}_{_{f}}^{S})) or (PDF) of the summed facies net volumes (\tilde{F}_{wv|n}_{_{f}}^{S}) for the total number of facies model realizations (Nₘ) is calculated from a histogram of the summed facies net volumes using techniques well known in the art. The summed facies net volumes may be represented as:

$${\tilde{F}}_{wv \vert {n}_{f}}^{S} = {\sum }_{{n}_{m} = 1}^{{N}_{m}} {\tilde{F}}_{wv \vert {n}_{m} , {n}_{f}}^{S} \qquad ( 14 )$$

where (\tilde{F}_{wv|n}_{ₘ}_{,n}_{_{f}}^{S}) is the summed facies net volumes from step 312 for each facies model realization (nₘ).

In step 316, a cumulative distribution function (Q(\tilde{F}_{wv|n}_{_{f}}^{S})) or CDF is calculated using the probability density function (q(\tilde{F}_{wv|n}_{_{f}}^{S})) from step 315 and techniques well known in the art.

In step 317, a facies net volume (\tilde{F}_{wv|n}_{ₘ}_{,n}_{_{f}}^{S}) for a single facies model realization (nₘ) from step 312 is selected using the CDF from step 316. For example, the facies net volume (\tilde{F}_{wv|n}_{ₘ}_{,n}_{_{f}}^{S}) selected at P50 is tied to a single facies model realization (nₘ). If no discrete facies net volume (\tilde{F}_{wv|n}_{ₘ}_{,n}_{_{f}}^{S}) corresponding to a single facies model realization (nₘ) can be selected, then the closest facies net volume (\tilde{F}_{wv|n}_{ₘ}_{,n}_{_{f}}^{S}), in terms of absolute difference, to P50 may be selected by solving:

δ_{F}_{_{wv}}=minₙ_{ₘ}₌₁^{N}^{ₘ}|F_{wv|n}_{ₘ}−F_{wv|P50}| (15)

where (δ_{F}_{_{wv}}) represents the minimized absolute difference between the facies model realization (F_{wv|n}_{ₘ}) corresponding with the closest facies net volume (\tilde{F}_{wv|n}_{ₘ}_{,n}_{_{f}}^{S}) to P50 and the facies model realization at P50 (F_{wv|P50}). The facies model realization (nₘ) at P50 is the median facies model realization for the selected facies net volume (\tilde{F}_{wv|n}_{ₘ}_{,n}_{_{f}}^{S}). In addition to the median (impact) facies model realization, the method 300 can also be used to identify the facies model realization models with the lowest impact as well as the highest impact to represent the entire space of model uncertainty over all quantiles of interest. Thus, the selection of the desired or preferred facies model realization (nₘ) is based on the facies net volume selected in step 317 as a function of the desired or preferred CDF.

### EXAMPLE

In this example of the method 100, a synthetic model of the Brugge field was used. The stratigraphy of the Brugge field combines four different depositional environments: i) fluvial (discrete sand bodies in shale); ii) lower shore facie (contains loggers: carbonate concretions), iii) upper shore face (contains loggers: carbonate concretions); and iv) sandy shelf with irregular carbonate patches.

A group of 400 high-resolution facies model realizations of the Brugge field (211×76×56, i.e., approximately 900 k grid-cells) was generated using the DecisionSpace® Desktop Earth Modeling API. The top-layers of nine (9) arbitrarily selected facies model realizations are illustrated in FIG. 5 where shale and sand are distinguished by a gray-scale.

The synthetic model of the Brugge field contains five different facies types, which are identified in Table 1 below with corresponding facies net values.

TABLE 1

| No. | Lithofacies name | Net value |
|---|---|---|
| 0 | Barrier sand | 0 |
| 1 | Sandstone | 0.4464 |
| 2 | Shoreface sand | 0.2321 |
| 3 | Shale | 0.1786 |
| 4 | Carbonate cemented sand | 0.1429 |

Based on Table 1, sandstone facies was selected as the most prominent facies according to step 105 in FIG. 1. In order to calculate the facies net volume in step 109 using equation (4), grid-cell dimensions of Δx=45.315 m, Δy=21.131 m, Δz=4.526 m and k=56 (the number of vertical layers in the synthetic model) were used to calculate the volume using equation (3) in step 108 of FIG. 1.

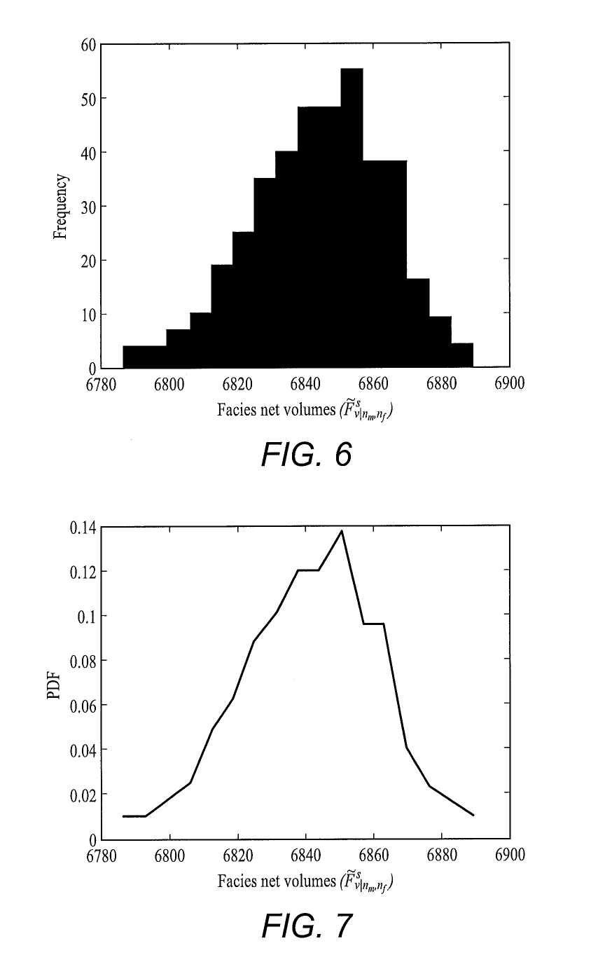

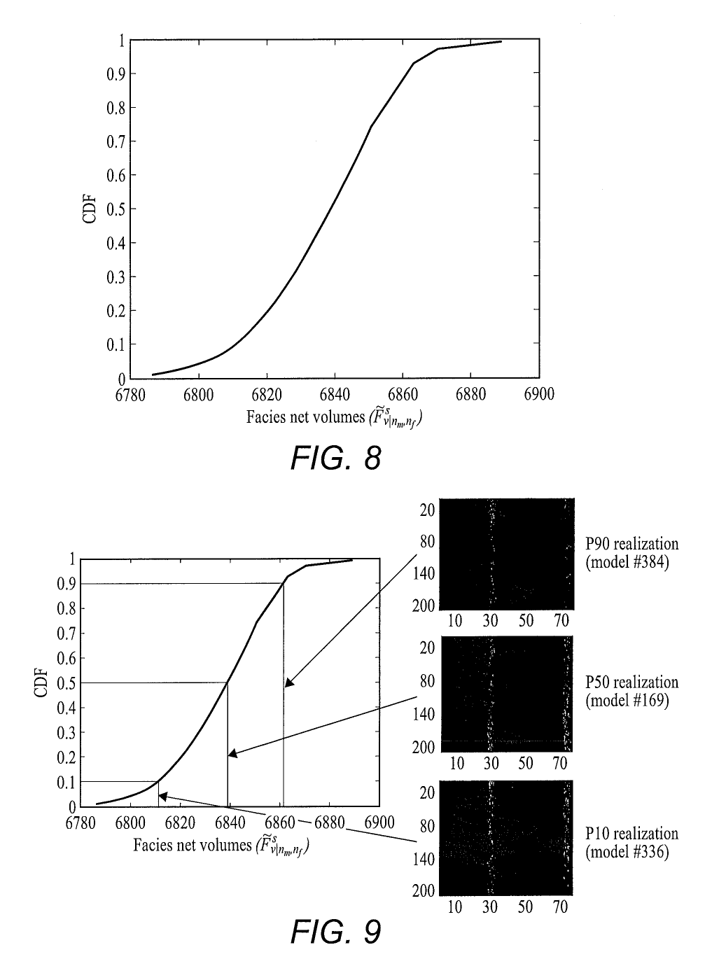

A histogram of the summed facies net volumes (\tilde{F}_{v|n}_{ₘ}_{,n}_{_{f}}^{s}) from step 112 is illustrated in FIG. 6 for the group of 400 facies model realizations. Based on the histogram in FIG. 6, a probability density function (PDF) and a corresponding cumulative distribution function (CDF) were calculated according to steps 115 and 116 in FIG. 1, respectively, which are illustrated in FIGS. 7 and 8, respectively.

The CDF illustrated in FIG. 8 was used to select/rank the facies model realizations with respect to the median facies model realization at P50 and the facies model realizations with the lowest and highest impact at P10 and P90, respectively.

Based on the probabilities given in Table 2 below, the corresponding facies net volumes were selected using equation (7) in step 117 of FIG. 1. In this example, the facies net volumes at P10, P50 and P90 correspond to facies model realizations 336, 169 and 384, respectively, which are illustrated in FIG. 9.

TABLE 2

| | Facies net volume |
|---|---|
| Probability | (\tilde{F}_{v\|n}_{ₘ}_{, n}_{_{f}}^{s}) |
| P10 | 6810 |
| P50 | 6839.33 |
| P90 | 6860.67 |

### System Description

The present invention may be implemented through a computer-executable program of instructions, such as program modules, generally referred to software applications or application programs executed by a computer. The software may include, for example, routines, programs, objects, components, data structures, etc., that perform particular tasks or implement particular abstract data types. DecisionSpace® Desktop Earth Modeling, which is a commercial software application marketed by Landmark Graphics Corporation, may be used as an interface application to implement the present invention. The software may also cooperate with other code segments to initiate a variety of tasks in response to data received in conjunction with the source of the received data. The software may be stored and/or carried on any variety of memory such as CD-ROM, magnetic disk, bubble memory and semiconductor memory (e.g., various types of RAM or ROM). Furthermore, the software and its results may be transmitted over a variety of carrier media such as optical fiber, metallic wire, and/or through any of a variety of networks, such as the Internet.

Moreover, those skilled in the art will appreciate that the invention may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present invention. The invention may be practiced in distributed-computing environments where tasks are performed by remote-processing devices that are linked through a communications network. In a distributed-computing environment, program modules may be located in both local and remote computer-storage media including memory storage devices. The present invention may therefore, be implemented in connection with various hardware, software or a combination thereof, in a computer system or other processing system.

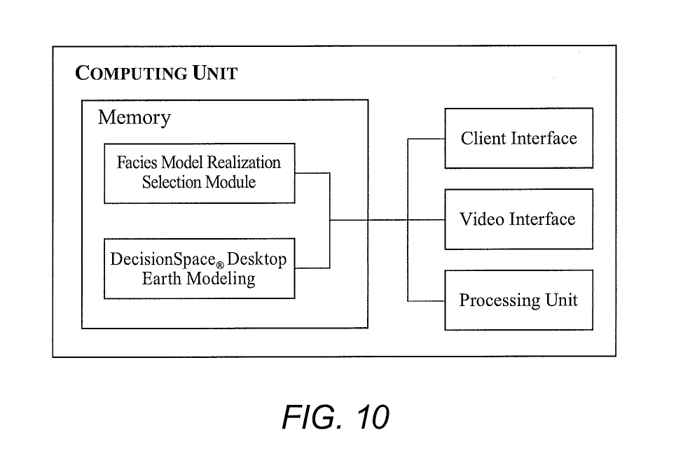

Referring now to FIG. 10, a block diagram illustrates one embodiment of a system for implementing the present invention on a computer. The system includes a computing unit, sometimes referred to as a computing system, which contains memory, application programs, a client interface, a video interface, and a processing unit. The computing unit is only one example of a suitable computing environment and is not intended to suggest any limitation as to the scope of use or functionality of the invention.

The memory primarily stores the application programs, which may also be described as program modules containing computer-executable instructions, executed by the computing unit for implementing the present invention described herein and illustrated in FIGS. 1 and 3. The memory therefore, includes a facies model realization selection module, which enables the methods illustrated and described in reference to FIGS. 1 and 3, and integrates functionality from the remaining application programs illustrated in FIG. 10. The facies model realization selection module, for example, may be used to execute many of the functions described in reference to the methods 100 and 300 in FIGS. 1 and 3, respectively. DecisionSpace® Desktop Earth Modeling may be used for example, as an interface application to implement the facies model realization selection module and to utilize the results of the method 100 in FIG. 1 and the method 300 in FIG. 3.

Although the computing unit is shown as having a generalized memory, the computing unit typically includes a variety of computer readable media. By way of example, and not limitation, computer readable media may comprise computer storage media The computing system memory may include computer storage media in the form of volatile and/or nonvolatile memory such as a read only memory (ROM) and random access memory (RAM). A basic input/output system (BIOS), containing the basic routines that help to transfer information between elements within the computing unit, such as during start-up, is typically stored in ROM. The RAM typically contains data and/or program modules that are immediately accessible to and/or presently being operated on by the processing unit. By way of example, and not limitation, the computing unit includes an operating system, application programs, other program modules, and program data.

The components shown in the memory may also be included in other removable/non-removable, volatile/nonvolatile computer storage media or they may be implemented in the computing unit through an application program interface (“API”) or cloud computing, which may reside on a separate computing unit connected through a computer system or network. For example only, a hard disk drive may read from or write to non-removable, nonvolatile magnetic media, a magnetic disk drive may read from or write to a removable, non-volatile magnetic disk, and an optical disk drive may read from or write to a removable, nonvolatile optical disk such as a CD ROM or other optical media. Other removable/non-removable, volatile/non-volatile computer storage media that can be used in the exemplary operating environment may include, but are not limited to, magnetic tape cassettes, flash memory cards, digital versatile disks, digital video tape, solid state RAM, solid state ROM, and the like. The drives and their associated computer storage media discussed above provide storage of computer readable instructions, data structures, program modules and other data for the computing unit.

A client may enter commands and information into the computing unit through the client interface, which may be input devices such as a keyboard and pointing device, commonly referred to as a mouse, trackball or touch pad. Input devices may include a microphone, joystick, satellite dish, scanner, or the like. These and other input devices are often connected to the processing unit through a system bus, but may be connected by other interface and bus structures, such as a parallel port or a universal serial bus (USB).

A monitor or other type of display device may be connected to the system bus via an interface, such as a video interface. A graphical user interface (“GUI”) may also be used with the video interface to receive instructions from the client interface and transmit instructions to the processing unit. In addition to the monitor, computers may also include other peripheral output devices such as speakers and printer, which may be connected through an output peripheral interface.

Although many other internal components of the computing unit are not shown, those of ordinary skill in the art will appreciate that such components and their interconnection are well known.

While the present invention has been described in connection with presently preferred embodiments, it will be understood by those skilled in the art that it is not intended to limit the invention to those embodiments. It is therefore, contemplated that various alternative embodiments and modifications may be made to the disclosed embodiments without departing from the spirit and scope of the invention defined by the appended claims and equivalents thereof.

1. A method for selecting a facies model realization, comprising:
a) selecting a grid-cell or window location for a facies model realization;
b) selecting a most prominent facies for facies within the facies model realization at the grid-cell or window location;
c) calculating a volume comprising the selected grid-cell or window location using a computer processor;
d) calculating a facies net volume based on the most prominent facies selected and the volume;
e) calculating a probability density function of the facies net volume;
f) calculating a cumulative distribution function of the facies net volume using the probability density function; and
g) selecting the facies model realization if the cumulative distribution function for the facies net volume meets a predetermined value.

2. The method of claim 1, further comprising:
h) repeating steps a) and b) in claim 1 for each grid-cell or window with the same (i,j) coordinates for the facies model realization;
i) summing the most prominent facies;
j) calculating another volume comprising each selected grid-cell or window location with the same (i,j) coordinates and a different (k) coordinate;
k) calculating another facies net volume based on the sum of the most prominent facies and the another volume;
l) repeating steps h)-k) for each grid-cell or window with the same (k) coordinate for the facies model realization;
m) summing the another facies net volume(s);
n) repeating steps h)-m) for each facies model realization;
o) calculating a probability density function of the summed another facies net volume(s) for all facies model realizations;
p) calculating a cumulative distribution function of the summed another facies net volume(s) for all facies model realizations using the probability density function of the summed another facies net volumes for all facies model realizations; and
q) selecting a facies model realization based on the cumulative distribution function of a corresponding another facies net volume.

3. The method of claim 1, wherein a histogram of the facies net volume is used to calculate the probability density function of the facies net volume.

4. The method of claim 1, wherein a histogram of the summed another facies net volume(s) for all facies model realizations is used to calculate the probability density function of the summed another facies net volume(s) for all facies model realizations.

5. The method of claim 2, wherein the summed another facies net volume(s) for all facies model realizations is determined by adding the summed another facies net volume(s) for each facies model realization.

6. The method of claim 1, wherein the selection of the most prominent facies is a facies with a highest net vale for the facies within the facies model realization at the grid-cell or window location.

7. A non-transitory program carrier device tangibly carrying computer executable instructions for selecting a facies model realization, the instructions being executable to implement:
a) selecting a grid-cell or window location for a facies model realization;
b) selecting a most prominent facies for facies within the facies model realization at the grid-cell or window location;
c) calculating a volume comprising the selected grid-cell or window location;
d) calculating a facies net volume based on the most prominent facies selected and the volume;
e) calculating a probability density function of the facies net volume;
calculating a cumulative distribution function of the facies net volume using the probability density function; and
g) selecting the facies model realization if the cumulative distribution function for the facies net volume meets a predetermined value.

8. The program carrier device of claim 7, further comprising:
h) repeating steps a) and b) in claim 7 for each grid-cell or window with the same (i,j) coordinates for the facies model realization;
i) summing the most prominent facies;
j) calculating another volume comprising each selected grid-cell or window location with the same (i,j) coordinates and a different (k) coordinate;
k) calculating another facies net volume based on the sum of the most prominent facies and the another volume;
l) repeating steps h)-k) for each grid-cell or window with the same (k) coordinate for the facies model realization;
m) summing the another facies net volume(s);
n) repeating steps h)-m) for each facies model realization;
o) calculating a probability density function of the summed another facies net volume(s) for all facies model realizations;
p) calculating a cumulative distribution function of the summed another facies net volume(s) for all facies model realizations using the probability density function of the summed another facies net volumes for all facies model realizations; and
q) selecting a facies model realization based on the cumulative distribution function of a corresponding another facies net volume.

9. The program carrier device of claim 7, wherein a histogram of the facies net volume is used to calculate the probability density function of the facies net volume.

10. The program carrier device of claim 7, wherein a histogram of the summed another facies net volume(s) for all facies model realizations is used to calculate the probability density function of the summed another facies net volume(s) for all facies model realizations.

11. The program carrier device of claim 8, wherein the summed another facies net volume(s) for all facies model realizations is determined by adding the summed another facies net volume(s) for each facies model realization.

12. The program carrier device of claim 7, wherein the selection of the most prominent facies is a facies with a highest net vale for the facies within the facies model realization at the grid-cell or window location.

13. A method for selecting a facies model realization, comprising:
a) selecting a most prominent facies for facies within a facies model realization at each grid-cell or window location;
b) summing the most prominent facies for each grid-cell or window location with the same (i,j) coordinates;
c) calculating a volume comprising each grid-cell or window location with the same (i,j) coordinates and a different (k) coordinate using a computer processor;
d) calculating a facies net volume for each volume based on the sum of the most prominent facies for each grid-cell or window location with the same (i,j) coordinates and a respective volume comprising each grid-cell or window location with the same (i,j) coordinates;
e) summing the facies net volume(s);
f) repeating steps a) e) for each facies model realization;
g) calculating a probability density function of the summed facies net volume(s) for all facies model realizations;
h) calculating a cumulative distribution function of the summed facies net volume(s) for all facies model realizations using the probability density function; and
i) selecting a facies model realization based on the cumulative distribution function of a corresponding facies net volume.

14. The method of claim 13, wherein a histogram of the summed facies net volume(s) for all facies model realizations is used to calculate the probability density function of the summed facies net volume(s) for all facies model realizations.

15. The method of claim 13, wherein the summed facies net volume(s) for all facies model realizations is determined by adding the summed facies net volume(s) for each facies model realizations.

16. The method of claim 13, wherein the selection of the most prominent facies is a facies with a highest net value for the facies within the facies model realization at each grid-cell or window location.

17. A non-transitory program carrier device tangibly carrying computer executable instructions for selecting a facies model realization, the instructions being executable to implement:
a) selecting a most prominent facies for facies within a facies model realization at each grid-cell or window location;
b) summing the most prominent facies for each grid-cell or window location with the same (i,j) coordinates;
c) calculating a volume comprising each grid-cell or window location with the same (i,j) coordinates and a different (k) coordinate;
d) calculating a facies net volume for each volume based on the sum of the most prominent facies for each grid-cell or window location with the same (i,j) coordinates and a respective volume comprising each grid-cell or window location with the same (i,j) coordinates;
e) summing the facies net volume(s);
f) repeating steps a) e) for each facies model realization;
g) calculating a probability density function of the summed facies net volume(s) for all facies model realizations;
h) calculating a cumulative distribution function of the summed facies net volume(s) for all facies model realizations using the probability density function; and
i) selecting a facies model realization based on the cumulative distribution function of a corresponding facies net volume.

18. The program carrier device of claim 17, wherein a histogram of the summed facies net volume(s) for all facies model realizations is used to calculate the probability density function of the summed facies net volume(s) for all facies model realizations.

19. The program carrier device of claim 17, wherein the summed facies net volume(s) for all facies model realizations is determined by adding the summed facies net volume(s) for each facies model realizations.

20. The program carrier device of claim 17, wherein the selection of the most prominent facies is a facies with a highest net value for the facies within the facies model realization at each grid-cell or window location.
